(19) United States
(12) Patent Application Publication
(10) Pub. No.: US 2025/0147937 A1
(43) Pub. Date: May 8, 2025

(54) DATA CLEANING DEVICE AND DATA CLEANING METHOD

(71) Applicant: INSTITUTE FOR INFORMATION INDUSTRY, TAIPEI CITY (TW)

(72) Inventors: Yu-Chen TSAI, TAIPEI CITY (TW); Ming-Fang WENG, TAIPEI CITY (TW)

(73) Assignee: INSTITUTE FOR INFORMATION INDUSTRY, TAIPEI CITY (TW)

(21) Appl. No.: 18/522,849

(22) Filed: Nov. 29, 2023

(30) Foreign Application Priority Data
Nov. 6, 2023 (TW) 112142619

(51) Int. Cl. G06F 16/215; G06F 16/25

(52) U.S. Cl. CPC G06F 16/215; G06F 16/258

(57) ABSTRACT

The present invention is a data cleaning device executing a data cleaning method. The data cleaning method includes executing an application, and executing a prompt plugin management program. The operation of executing the prompt plugin management program includes generating a prompt instruction based on an unformatted content via a first prompt template, transmitting the prompt instruction to a first device, and receiving a formatted content from the first device. The formatted content is generated by the first device based on the prompt instruction through a large language model.

### CROSS-REFERENCE TO RELATED APPLICATIONS

This application claims the priority benefit of TW application serial No. 112142619, filed on Nov. 6, 2023. The entirety of the above-mentioned patent application is hereby incorporated by reference herein and made a part of the specification.

### BACKGROUND OF THE INVENTION

### 1. Field of the Invention

The present invention relates to a data cleaning device and data cleaning method, and particularly relates to a data cleaning device and data cleaning method implementing a large language model (LLM).

### 2. Description of the Related Art

Data cleaning technique refers to the techniques including processing unformatted content and generating formatted content that meets an application requirement. Traditionally, human manual review is implemented to recognize the unformatted content, and further transform the recognized outcome into a formatted content meeting the application requirement. However, processing unformatted content by human manual review not only wastes human resources and times, but also is inefficient. The speed at which data is processed manually is far from the speed at which data is generated.

In sum, the data cleaning technique of unformatted content requires further development to address the problems as stated above.

### SUMMARY OF THE INVENTION

In light of the limitation in the processing technique for the unformatted content, the present invention provides a data cleaning device and data cleaning method to address the problems.

The data cleaning device of the present invention includes:
a storage unit, configured to store an application, a prompt plugin managing program, and a prompt template registry;
a processor, connected to the storage unit, configured to read the application from the storage unit and execute the application, wherein executing the application includes:
   executing the prompt plugin managing program to access a first prompt template from at least one prompt template indicated in the prompt template registry;
   generating a prompt instruction based on an unformatted content through the first prompt template and transmitting the prompt instruction to a first device; and
   receiving a formatted content from the first device, wherein the first device generates the formatted content based on the prompt instruction through a large language model (LLM).

The present invention further provides a data cleaning method, implemented by a data cleaning device, comprising the steps of:
reading an application and executing the application, wherein executing the application includes:
   executing a prompt plugin managing program to access a first prompt template from at least one prompt template indicated in the prompt template registry;
   generating a prompt instruction based on an unformatted content through the first prompt template and transmitting the prompt instruction to a first device; and
   receiving a formatted content from the first device, wherein the first device generates the formatted content based on the prompt instruction through a LLM.

The data cleaning device of the present invention provides management, presentation, and execution functions for prompt templates by executing a prompt plugin managing program under the application. When executing the prompt plugin managing program, the application accesses a first prompt template from prompt templates provided in the prompt template registry, and further generates a complete prompt instruction based on unformatted content through the first prompt template. The prompt instruction is sent from the data cleaning device to a first device, enabling the LLM of the first device to process the unformatted content in accordance with the requirements of the first prompt template, producing the designated formatted content. Finally, the completed formatted content is received by the data cleaning device.

In the present invention, only the activation of the prompt plugin managing program and the direction of the prompt template registry is necessary from generating unformatted content to receive formatted content, providing the unformatted content to the first prompt template to generate the prompt instruction, and transmitting the prompt instruction to the LLM of the first device to produce formatted content, significantly reducing the operational process of converting unformatted content into formatted content. By managing and executing prompt templates through plugins in the application, affection of the operation of the original core system program of the application is avoided, and users of the application do not need to change the habits of using the application, such as not needing to turn on an additional data cleaning application or device. Moreover, prompt instructions that meet specific application requirements can be directly applied using templates predefined by prompt engineering with multiple prompt templates presented in the prompt template registry, ensuring the formatted content generated by the LLM meets the specific application requirements in terms of data type and format, thereby improving the technical issues in current technologies.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a data cleaning system according to an embodiment of the present invention.

FIG. 2 is a flowchart of a data cleaning method according to an embodiment of the present invention.

FIG. 3 is a block diagram of an application state of a data cleaning device executing an application according to an embodiment of the present invention.

FIG. 4 is an exemplary prompt instruction generated by a data cleaning device according to an embodiment of the present invention.

FIG. 5 is an exemplary formatted content received by a data cleaning device according to an embodiment of the present invention.

FIG. 6 is another exemplary prompt instruction generated by a data cleaning device according to an embodiment of the present invention.

FIG. 7 is another exemplary formatted content received by a data cleaning device according to an embodiment of the present invention.

### DETAILED DESCRIPTION OF THE INVENTION

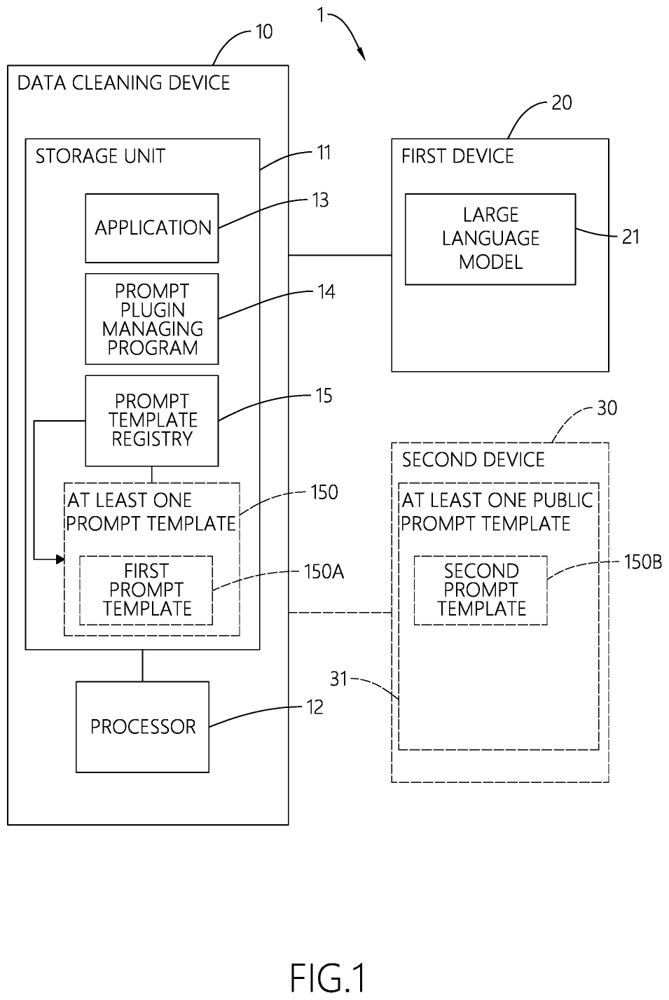

With reference to FIG. 1, which is a block diagram of a data cleaning system 1 according to an embodiment of the present invention. The data cleaning system 1 includes a data cleaning device 10 and a first device 20. The data cleaning device 10 includes a storage unit 11 and a processor 12, and is connected (e.g., communicational connection) to the first device 20. The storage unit 11 is configured to store an application 13, a prompt plugin managing program 14, a prompt template registry 15, and at least one prompt template 150. The at least one prompt template 150 may include a first prompt template 150A. The at least one prompt template 150 may also include other prompt templates (not shown in the figures). The processor 12 is connected to the storage unit 11 to read the application 13, the prompt plugin managing program 14, and the prompt template registry 15 from the storage unit 11. The prompt plugin managing program 14 is configured as a plugin module for the application 13. When the processor 12 executes the application 13, it can simultaneously execute the prompt plugin managing program 14 to perform management functions of the at least one prompt template 150. The prompt template registry 15 is used to manage (e.g., track or update) the at least one prompt template 150 and/or store related information of the at least one prompt template 150, such as template name, template function, template version and/or required resource definition, but not limited to these. The first device 20 includes (e.g., stores) a large language model (LLM) 21. The LLM 21 can be a natural language model which completes training of a vast quantity of texts based on artificial intelligence. For example, the LLM may be a chat generative pre-trained transformer (chatGPT) or its derivatives (such as Generative Pre-trained Transformer 4 (GPT-4)), LLM Meta AI (LLaMA), Pathways Language Model (PaLM) or its derivatives (such as PaLM 2 or Bard), any model with similar functions to the above models, or a combination of the above models, but not limited to these.

In one embodiment, the data cleaning device 10 may also be connected (e.g., communicationally connected) to a second device 30. The second device 30 may be used to store at least one public prompt template 31, which may include a second prompt template 150B. The at least one public prompt template 31 may also include other public prompt templates (not shown in the figures). Since the second device 30 is optional in this invention, it is shown in dashed lines. The second device 30, for example, is an external device (such as a server) used to store the at least one public prompt template 31, for engineers to upload the at least one public prompt template 31 which completes the prompt engineering, and for the prompt plugin managing program 14 to connect and access upon activation to execute the following operations: synchronizing and checking available prompt templates in the at least one public prompt template 31, checking information of the available prompt templates, and downloading the available prompt templates that meet application requirements (such as the second prompt template 150B) to the data cleaning device 10, in response to the activation of the prompt plugin managing program 14. Correspondingly, the data cleaning device 10 can install and deploy the downloaded prompt templates.

It should be noted that, in FIG. 1, the at least one prompt template 150 is exemplarily shown in dashed lines within the storage unit 11 of the data cleaning device 10 to denote that the at least one prompt template 150 can be temporarily stored in the storage unit 11 in this invention. The application 13 or the prompt plugin managing program 14 can download and store the at least one prompt template 150 from an external device (such as the second device 30) into the storage unit 11 during execution or upon activation. The storage unit 11 can be any data storage device that can be read and executed by the processor 12, such as a memory, a hard disk, a solid-state drive, a flash memory, or other suitable data storage devices for storing codes, but not limited to these.

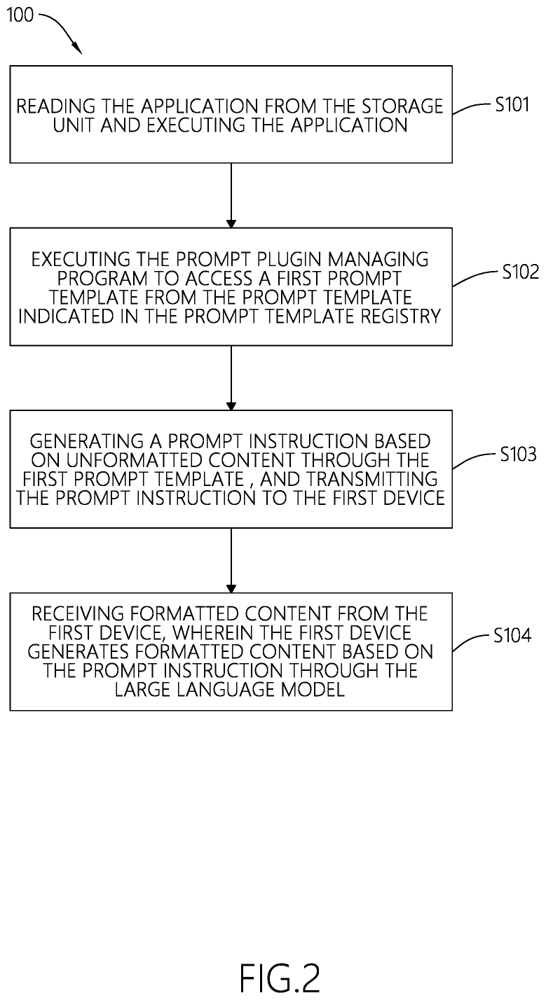

Refer to also FIG. 2, which illustrates a flowchart of a data cleaning method 100 according to an embodiment of the present invention. The data cleaning method 100 can be applied to the data cleaning device 10 shown in FIG. 1, and can be compiled into a program to be executed by the processor 12. The data cleaning method 100 includes the following steps: Step S101: reading the application 13 from the storage unit 11 and executing the application 13; Step S102: executing (e.g., activating) the prompt plugin managing program 14 to access a first prompt template 150A from at least one prompt template 150 indicated (e.g., pointed to) in the prompt template registry 15; Step S103: generating a prompt instruction based on unformatted content through the first prompt template 150A, and transmitting the prompt instruction to the first device 20; Step S104: receiving formatted content from the first device 20, wherein the first device 20 generates formatted content based on the prompt instruction through the LLM 21. In other words, the prompt plugin managing program 14 generates a prompt instruction from the unformatted content through the predefined first prompt template 150A, and transmits the prompt instruction to the first device 20 for the LLM 21 of the first device 20 to format the unformatted content, thereby significantly reducing the human resources consumption and times consumption, errors, and inefficiency problems caused by manually processing the unformatted content.

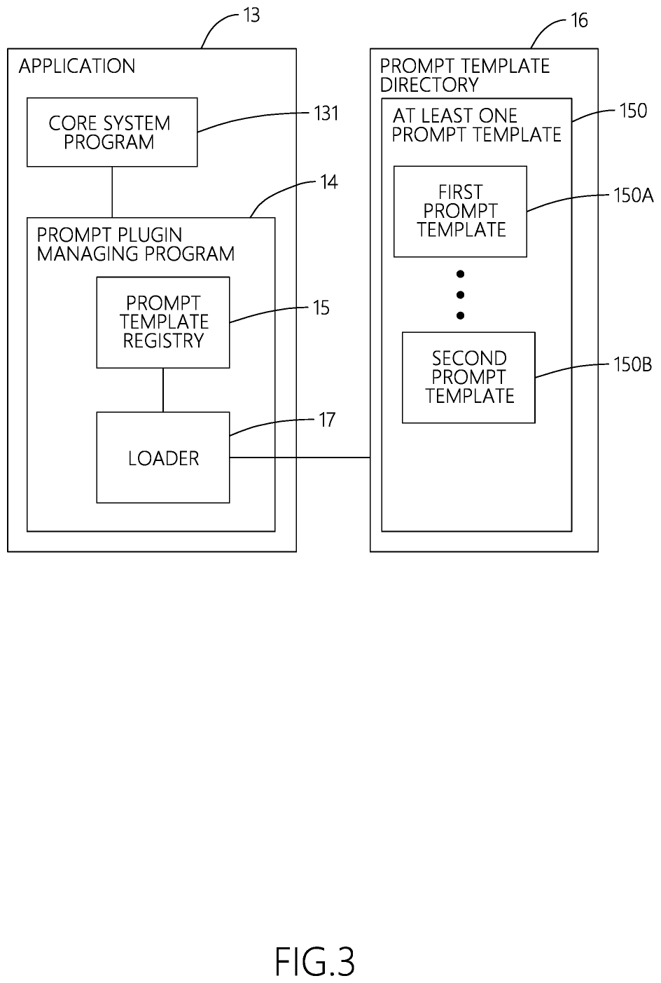

Please also refer to FIG. 3, which illustrates a block diagram of an application state of the data cleaning device 10 executing the application 13 according to an embodiment of the present invention. The application 13 may include a core system program 131 and the prompt plugin managing program 14. The prompt plugin managing program 14 may include the prompt template registry 15 and a loader 17, wherein the prompt template registry 15 can load at least one prompt template 150 from a prompt template directory 16 at a preset address. The core system program 131 can be any program with the function of inputting or receiving input content (e.g., any data such as text, numbers, or symbols) of a user. For example, the core system program 131 may be a text editor, a medical information integration system program, a financial information integration system program, any professional information integration system program, online meeting or online chat room, etc., and not limited herein. The core system program 131 can be the main functional program of application 13. The core system program 131 may generate unformatted content based on the input content of the user. The input content of the user, for example, can be any content input by the user through a text editor, or any content input by the user performing content recognition on an image file. In one embodiment, the unformatted content can be medical field data, such as handwritten patient data, medical records, tests data, diagnosis, medical imaging reports, or certificates of diagnosis by medical personnel, but not limited to these. In one embodiment, the unformatted content can be finance data, online meeting chat content, and online chat room chat content, but not limited to these.

In some embodiments, the application 13 or the core system program 131 can define the functions, resources, services, and/or data exchange methods provided to the at least one prompt template 150 and/or the at least one public prompt template 31 through a service interface (not shown in the figures, such as data exchange protocols). In some embodiments, the prompt plugin managing program 14 can predefine a purpose of each of the at least one prompt template 150 and/or the at least one public prompt template 31 (e.g., the required purpose) through a prompt template service interface (not shown in the figures, such as protocols for service providing), such as for which application requirement and/or professional field they are used, so that the at least one prompt template 150 and/or at least one public prompt template 31 can be loaded and executed by the application 13, or specifically by the prompt plugin managing program 14 within.

In some embodiments, based on the contents of input fields in the unformatted content, the application 13 can select a corresponding prompt template (e.g., one that meets application requirements) from the at least one prompt template 150 indicated by the prompt template registry 15 (for example, but not limited to, the first prompt template 150A and/or the second prompt template 150B) to generate prompt instructions based on the unformatted content. In other embodiments, the application 13 can execute a corresponding prompt template (e.g., one that meets application requirements) based on user selection (e.g., from a dropdown menu displayed by application 13) (for example, but not limited to, the first prompt template 150A and/or the second prompt template 150B) to generate the prompt instruction based on the unformatted content.

Each of the at least one prompt template 150 and the at least one public prompt template 31 can include prompt content pre-generated by engineers implementing prompt engineering. Each of the at least one prompt template 150 can provide different formatting functions corresponding to different application requirements in order to generate different formatted contents. The formatting function is predefined during the prompt engineering based on different anticipated application scenarios, expected input information, expected output formats, and expected output data types.

More specifically, each of the at least one prompt template 150 and the at least one public prompt template 31 can include a plurality of prompt content blocks, different prompt content blocks may have different prompt contents, and the plurality of prompt content blocks may include an input content block. When the processor 12 generates the prompt instruction based on the unformatted content through one of the at least one prompt template 150 (e.g., the first prompt template 150A), the processor 12 embeds the unformatted content into the input content block of the one of the at least one prompt template 150, thereby generating the prompt instruction. Moreover, other blocks among the prompt content blocks can include at least one of output data type definitions (e.g., using true/false values to represent whether restrictions in categories are compliant, defining each of the restrictions with an explanation), output format definitions (e.g., json format, FHIR format), output example definitions (e.g., output examples including categories and explanations), and output restriction definitions (e.g., defining restrictions using explanations, representing phone numbers with number values, representing dates with YYYY-MM-DD).

In one embodiment, generating the prompt instruction based on the unformatted content through the one of at least one prompt template 150 (e.g., the first prompt template 150A) further includes performing preprocessing on the unformatted content to generate preprocessed unformatted content, and further generating the prompt instruction based on the preprocessed unformatted content. The preprocessing can at least include data cleaning processing, which may involve at least one of typo handling (e.g., correction), illegal character handling (e.g., correction or deletion), missing value handling (e.g., imputation), and data type handling (e.g., type conversion), but not limited to these.

In one embodiment, the data cleaning device 10 can be connected to the LLM 21 through an Application Programming Interface (API). When the first device 20 receives the prompt instruction and inputs the prompt instruction into the LLM 21, the LLM 21 generates the formatted content in the format instructed by the one of the at least one prompt template 150 (e.g., the first prompt template 150A) based on the unformatted content and information such as output data type definitions, output format definitions, output example definitions, and/or restriction definitions in the prompt instruction.

In one embodiment, when the data cleaning device 10 receives the formatted content from the first device 20, the data cleaning device 10 stores the formatted content in the storage unit 11 or to a destination device (not shown in the figures), and/or display the formatted content. The destination device, for example, may be an external server at the backend of application 13 and is used to uniformly store formatted contents from different source devices.

In one embodiment, the processor 12 may further clear resources used for executing (e.g., loading) the prompt plugin managing program 14, wherein the resources may include, but are not limited to, at least one storage space.

With reference to FIGS. 1 and 3, in an embodiment, the loader 17 can be used to download at least one prompt template among the at least one public prompt template 31 (e.g., the second prompt template 150B) from the second device 30, and store the downloaded prompt template in the prompt template directory 16 at the preset address in response to the activation of the prompt plugin managing program 14. The loader 17 can also be used to load the downloaded prompt template into the application 13 for execution by the application 13. More specifically, when the data cleaning device 10 executes the prompt plugin managing program 14, the prompt template registry 15 further scans the prompt template directory 16 at the preset address and loads the prompt templates from the prompt template directory 16 into application 13 through the loader 17. The loader 17 can load prompt templates from the prompt template directory 16 when the prompt plugin managing program 14 is activated (or executed). For simplicity of illustration, only a portion of the at least one prompt template 150 is shown in FIGS. 1 and 3, but the number of the at least one prompt template 150 is not limited to the number depicted in FIGS. 1 and 3.

Furthermore, the data cleaning device 10 executing the prompt plugin managing program 14 also includes updating the prompt template registry 15 according to the at least one prompt templates 150 (e.g., the second prompt template 150B) in the prompt template directory 16, thereby providing an updated prompt template registry 15 in the application 13. For example, the updated prompt template registry 15 can be displayed in a dropdown menu for user selection, or the plugin managing program 14 can be automatically triggered to execute (e.g., activate) the prompt template when the unformatted content is detected in the input field.

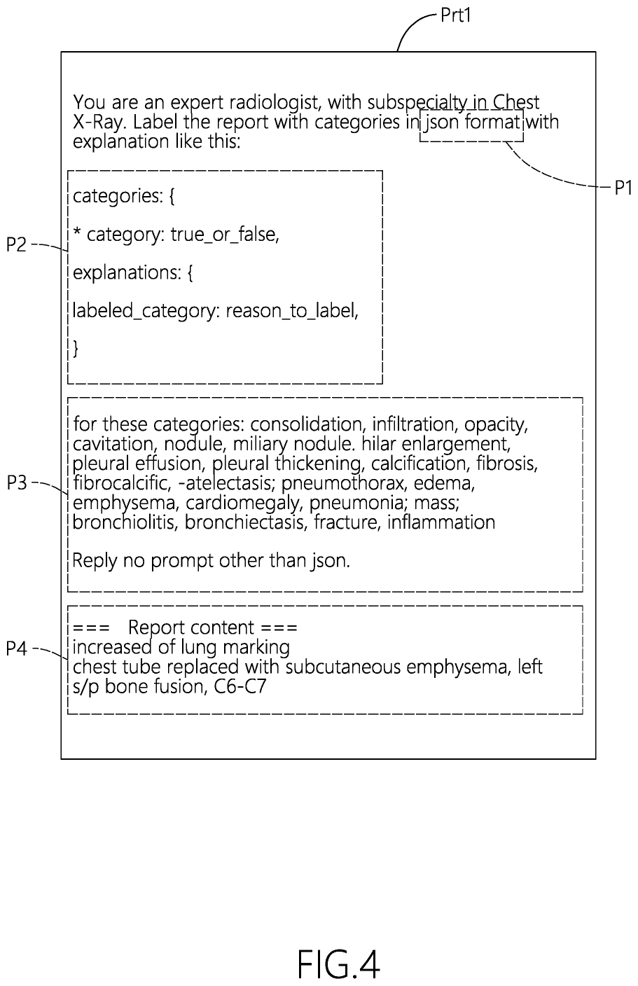

With reference to FIGS. 1 and 4, wherein FIG. 4 illustrates an exemplary prompt instruction Prt1 generated by the data cleaning device 10, and a purpose of the prompt instruction Prt1 is to instruct the LLM 21 of the first device 20 to format medical image labeling content and display the “categories” and “explanations” of the labeling content in json format. The exemplary prompt instruction Prt1 includes an output format definition P1 (i.e., json format) provided by a prompt template meeting medical image application requirements, an output example definition P2 (i.e., including categories and representing true/false values to indicate whether the categories are compliant, along with explanations defining each of the categories), a restriction condition definition P3 (i.e., defining the categories), and an input content block P4 (i.e., inputting based on unformatted medical image labeling content).

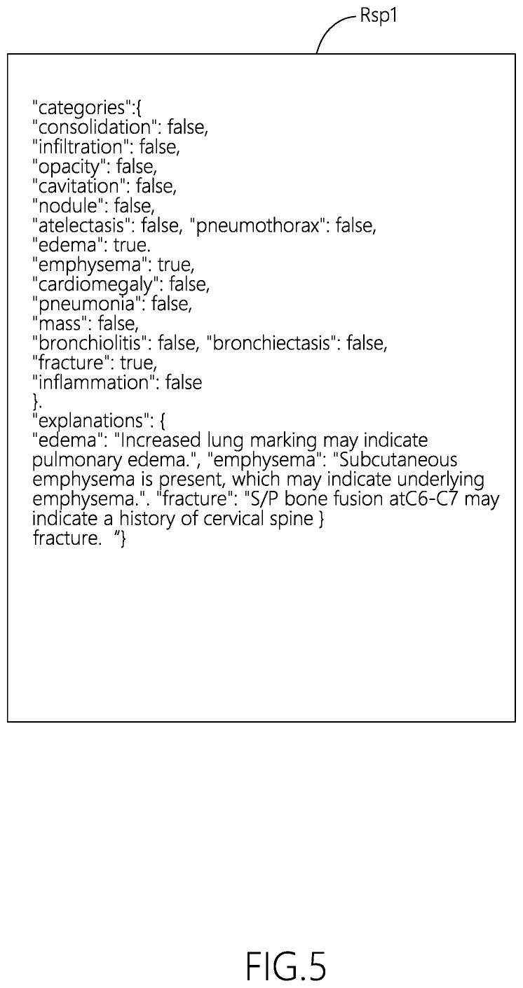

Further refer to FIG. 5, wherein FIG. 5 illustrates an exemplary formatted content Rsp1 received by the data cleaning device 10, generated through the data cleaning method 100 in FIG. 2, based on the exemplary prompt instruction Prt1 of FIG. 4. As shown in FIG. 5, the exemplary formatted content Rsp1 is generated according to the output format definition P1, the output example definition P2, the restriction condition definition P3, and the input content block P4 defined in the exemplary prompt instruction Prt1 of FIG. 4.

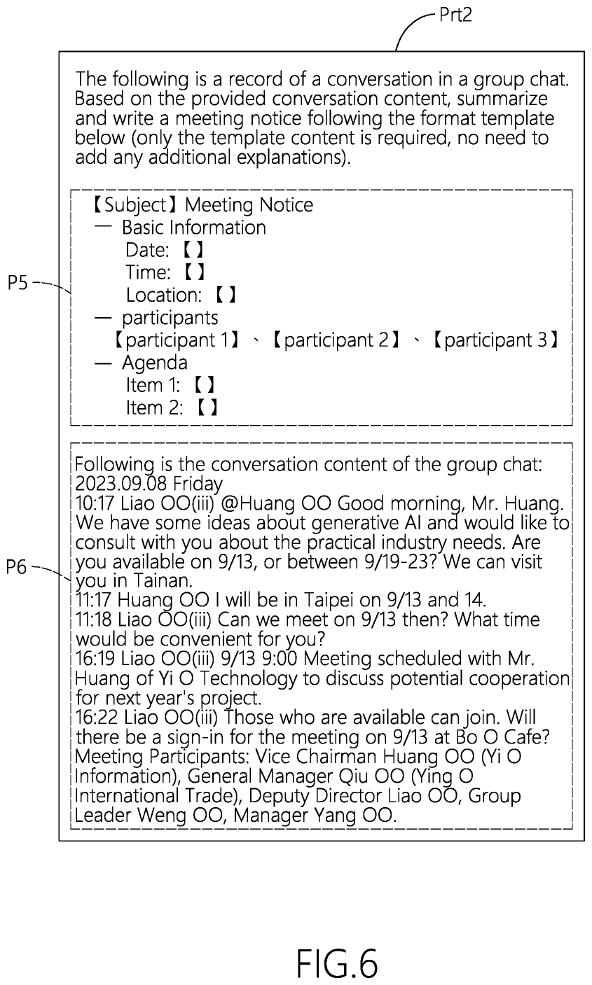

Please also refer to FIGS. 1 and 6, wherein FIG. 6 illustrates another exemplary prompt instruction Prt2 generated by the data cleaning device 10, and a purpose of the prompt instruction Prt2 is to instruct the LLM 21 of the first device 20 to generate a meeting notice with a specific format and field content for a record of a chatroom conversation with a group of people. The exemplary prompt instruction Prt2 includes an output format and example definition P5 provided by a prompt template meeting a meeting notice application requirement (i.e., headings such as “Basic Information”, “Participants”, “Topics”, etc., and their respective corresponding designated fields) and an input content block P6 (i.e., inputting based on the record of the chatroom conversation with the group of people, which is unformatted).

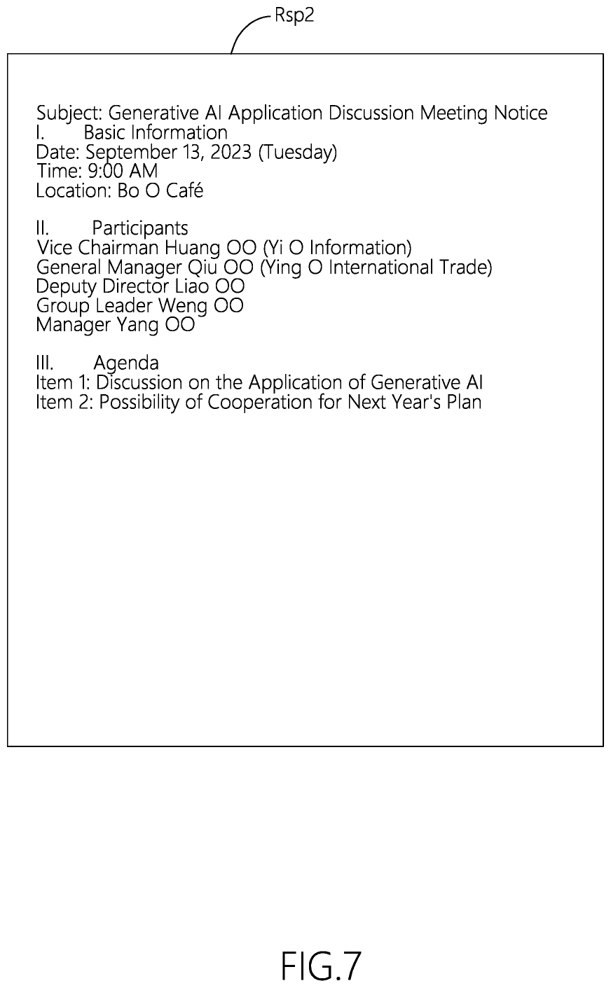

Further refer to FIG. 7, wherein FIG. 7 illustrates another exemplary formatted content Rsp2 received by the data cleaning device 10, generated through the data cleaning method 100 in FIG. 2, based on the exemplary prompt instruction Prt2 of FIG. 6. As shown in FIG. 7, the exemplary formatted content Rsp2 is generated based on the output format definition and example definition P5 and the input content block P6 defined in the exemplary prompt instruction Prt2 in FIG. 6.

From the two exemplary prompt instructions Prt1, Prt2 and their respective exemplary formatted contents Rsp1, Rsp2, it is obtained that the data cleaning device 10 and the data cleaning method 100 of this invention can be effectively applied to any application requirement that requires data cleaning (formatting processing) of unformatted content.

In summary, the data cleaning device and method of the present invention have at least the following benefits:

1. The prompt plugin managing program 14 does not affect the execution of the original application 13, so user(s) may not need to change the way they use the original application 13.

2. By using the prompt plugin managing program 14 to execute prompt templates with different functions, user(s) may select prompt templates according to their application needs, or the data cleaning device can automatically execute prompt templates for specific application requirements. There is no need for the user(s) to draft the prompt instructions themselves, thus improving the efficiency of generating the prompt instructions and resulting in effective prompt instructions.

3. Under the situations that the effective prompt instructions are generated, further applies the LLMs to perform data cleaning on unformatted contents to generate formatted contents.

All of these benefits can be used to improve the problem of the data cleaning technique of the unformatted content to be addressed in related art.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A data cleaning device, comprising:
a storage unit, configured to store an application, a prompt plugin managing program, and a prompt template registry;
a processor, connected to the storage unit, configured to read the application from the storage unit and execute the application, wherein executing the application comprises:
executing the prompt plugin managing program to access a first prompt template from at least one prompt template indicated in the prompt template registry;
generating a prompt instruction based on an unformatted content through the first prompt template and transmitting the prompt instruction to a first device; and
receiving a formatted content from the first device, wherein the first device generates the formatted content based on the prompt instruction through a large language model.

2. The data cleaning device of claim 1, wherein executing the prompt plugin managing program further comprises:
scanning a prompt template directory at a preset address; and
downloading at least one second prompt template from a second device through a loader and storing the at least one second prompt template in the prompt template directory at the preset address, in response to the execution of the prompt plugin managing program.

3. The data cleaning device of claim 2, wherein executing the prompt plugin managing program further comprises:
updating the prompt template registry according to the at least one second prompt template.

4. The data cleaning device of claim 2, wherein a purpose of each of the at least one second prompt template and the at least one prompt template is predefined through a prompt template service interface.

5. The data cleaning device of claim 1, wherein executing the application further comprises:
generating the unformatted content based on an input from a user.

6. The data cleaning device of claim 1, wherein the prompt instruction comprises at least one of an output data type definition, an output format definition, and an output example definition.

7. The data cleaning device of claim 1, wherein generating the prompt instruction based on the unformatted content through the first prompt template comprises:
performing a preprocessing on the unformatted content to generate a preprocessed unformatted content; and
generating the prompt instruction based on the preprocessed unformatted content, wherein the preprocessing comprises a data cleaning process.

8. The data cleaning device of claim 7, wherein the data cleaning process comprises at least one of a typo handling, an illegal character handling, a missing value handling, and a data type handling.

9. The data cleaning device of claim 1, wherein executing the application further comprises:
storing the formatted content or displaying the formatted content; and
clearing a resource used for executing the prompt plugin managing program, wherein the resource comprises at least one storage space.

10. A data cleaning method, implemented by a data cleaning device, comprising the steps of:
reading an application and executing the application, wherein executing the application comprises:
executing a prompt plugin managing program to access a first prompt template from at least one prompt template indicated in the prompt template registry;
generating a prompt instruction based on an unformatted content through the first prompt template and transmitting the prompt instruction to a first device; and
receiving a formatted content from the first device, wherein the first device generates the formatted content based on the prompt instruction through a large language model.

11. The data cleaning method of claim 10, wherein executing the prompt plugin managing program further comprises:
scanning a prompt template directory at a preset address; and
downloading at least one second prompt template from a second device through a loader and storing the at least one second prompt template in the prompt template directory at the preset address, in response to the execution of the prompt plugin managing program.

12. The data cleaning method of claim 11, wherein executing the prompt plugin managing program further comprises:
updating the prompt template registry according to the at least one second prompt template.

13. The data cleaning method of claim 11, wherein a purpose of each of the at least one second prompt template and the at least one prompt template is predefined through a prompt template service interface.

14. The data cleaning method of claim 10, wherein executing the application further comprises:
generating the unformatted content based on an input from a user.

15. The data cleaning method of claim 10, wherein the prompt instruction comprises at least one of an output data type definition, an output format definition, and an output example definition.

16. The data cleaning method of claim 10, wherein generating the prompt instruction based on the unformatted content through the first prompt template comprises:
performing a preprocessing on the unformatted content to generate a preprocessed unformatted content; and
generating the prompt instruction based on the preprocessed unformatted content, wherein the preprocessing comprises a data cleaning process.

17. The data cleaning method of claim 16, wherein the data cleaning process comprises at least one of a typo handling, an illegal character handling, a missing value handling, and a data type handling.

18. The data cleaning method of claim 10, wherein executing the application further comprises:
storing the formatted content or displaying the formatted content; and
clearing a resource used for executing the prompt plugin managing program, wherein the resource comprises at least one storage space.
